(19) United States
(12) Patent Application Publication
(10) Pub. No.: US 2012/0006223 A1
(43) Pub. Date: Jan. 12, 2012

(54) ANTIFOULING SURFACES AND METHODS FOR PRODUCTION THEREOF

(75) Inventor: Daniel Kellogg, Oceanside, CA (US)

(73) Assignee: ZODIAC POOL SYSTEMS, INC., Moorpark, CA (US)

(21) Appl. No.: 13/175,658

(22) Filed: Jul. 1, 2011

Related U.S. Application Data
(60) Provisional application No. 61/363,180, filed on Jul. 9, 2010.
(60) Provisional application No. 61/371,610, filed on Aug. 6, 2010.

(51) Int. Cl. C04B 14/34; C08K 3/10; C08K 3/08

(52) U.S. Cl. 106/15.05; 523/122

(57) ABSTRACT

Surfaces that are in contact with a body of water or that are periodically exposed to water can be susceptible to fouling. Described herein are antifouling surfaces that contain a matrix material and an antifouling effective amount of a metal additive in the matrix material. The matrix material can define a surface that is in contact with a body of water or that is periodically exposed to water, where the matrix material does not substantially degrade in the presence of water. Methods for inhibiting fouling of a surface are also described herein.

### CROSS-REFERENCE TO RELATED APPLICATIONS

This application claims the benefit of priority under 35 U.S.C. §119 from U.S. Provisional Patent Application No. 61/363,180, filed Jul. 9, 2010, and No. 61/371,610, filed Aug. 6, 2010, each of which is incorporated herein by reference in its entirety.

### STATEMENT REGARDING FEDERALLY SPONSORED RESEARCH OR DEVELOPMENT

Not applicable.

### FIELD OF THE INVENTION

The present invention generally relates to surfaces that are at least periodically in contact with water, and, more specifically, to prevention of fouling of these surfaces.

### BACKGROUND

Fouling refers to the accumulation of unwanted material on solid surfaces, most often in an aquatic environment or an environment in which the surface is at least periodically wet. Under such conditions, the fouling material can consist of either living organisms or non-living substances. Fouling resulting from the former is often referred to as biofouling. Illustrative living organisms which can produce biofouling can include, for example, algae, bacteria, and other microorganisms.

Biofouling can occur in almost any instance in which a surface is in contact with an aquatic environment. A number of techniques have been used in order to inhibit biofouling. Most of these techniques have focused on the aquatic environment itself, where biocides and dispersants have been used to maintain biomaterials at a level where biofouling is not a significant issue. Another approach to inhibiting biofouling has been to treat a surface in contact with an aquatic environment using a substance that prevents an organism from attaching thereto. Treatment of a surface to prevent biofouling can sometimes be economically prohibitive due to the cost of some biocides and other treatment media and the large surface areas that sometimes need to be treated. Very little attention has been paid to making the surface itself biocidal such that fouling of the surface can be inhibited.

In view of the foregoing, surfaces made from materials that have native antifouling activity would be of substantial benefit in the art. The present invention satisfies this need and provides related advantages as well.

### SUMMARY

In some embodiments, antifouling surfaces described herein include a matrix material defining a surface that is in contact with a body of water or that is periodically exposed to water, and an antifouling effective amount of a metal additive in the matrix material. The matrix material does not substantially degrade in the presence of water.

In some embodiments, antifouling surfaces described herein include a matrix material defining a surface that is in contact with a body of water or that is periodically exposed to water, and an antifouling effective amount of a metal additive in the matrix material that includes zero-valent silver or a silver salt. The matrix material does not substantially degrade in the presence of water.

In some embodiments, methods are described for inhibiting fouling of a surface that is in contact with a body of water or that is periodically exposed to water. The methods include incorporating an antifouling effective amount of a metal additive into a matrix material, and forming a surface defined by the matrix material that is in contact with a body of water or that is periodically exposed to water. The matrix material does not substantially degrade in the presence of water. The metal additive includes at least one zero-valent metal or at least one metal salt.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

Not applicable.

### DETAILED DESCRIPTION

The present disclosure is directed, in part, to antifouling surfaces. The present disclosure is also directed, in part, to methods for inhibiting fouling of surfaces that are in contact with a body of water or that are periodically exposed to water.

Certain metals or metal salts when dissolved or dispersed in water can have algicidal or algistatic properties. Illustrative metals that can have these properties include, for example, main group metals such as aluminum and tin, transition metals such as zinc and copper, or lanthanide metals such as cerium. Without being bound by theory or mechanism, it is believed that these metals can precipitate low levels of phosphate, which is an essential algal nutrient source, as highly insoluble phosphate salts. In addition, silver can impart antimicrobial properties to a solution. Accordingly, these metals and others can be added portionwise or continuously to a water source in order to prevent fouling of a surface in contact therewith. Although a surface that is continuously in contact with a body of water can be successfully protected from biofouling, the foregoing approach may not be applicable to surfaces that are only periodically wet, since there can oftentimes not be an identifiable body of water upon which to perform treatment.

Although the biocidal properties of certain metals and metal salts have been demonstrated in solution, it is not believed that these properties have been investigated in the solid phase, particularly for a surface that is in contact with a body of water or that is periodically exposed to water. That is, it is not believed that the algicidal, algistatic, or antimicrobial properties of metals or metal salts has been investigated when contained within a matrix material. There are a number of reasons for this lack of previous study, including, for example, the belief that in order to effectively interact with a biofouling organism, the metal or metal salt must be suitably dispersed in a liquid medium. According to conventional beliefs, a metal or metal salt immobilized within an insoluble matrix material would fail to interact with a biofouling organism. At best, a metal or metal salt would interact with a biofouling organism at the surface in an amount insufficient to confer antifouling properties, while the bulk of the metal or metal salt would remain buried within the bulk matrix material and unavailable for bioactivity.

It has been surprisingly recognized according to the embodiments described herein that incorporation of a metal or a metal salt within a matrix material can confer suitable antifouling properties to a surface that is in contact with a body of water or that is periodically exposed to water. Many metals and metal salts, particularly those that are known to confer antifouling properties to water, are available in bulk quantities from a variety of commercial suppliers at reasonable costs. Further, antifouling surfaces containing metals or metal salts can be relatively inexpensive, since only small amounts of the metals or metal salts can generally be needed to confer antifouling effectiveness. At the levels useful for conferring antifouling effectiveness to a surface, it is not believed that the physical properties of the matrix material are significantly impacted. Thus, an antifouling surface can maintain structural properties comparable to those of the native matrix material.

A further advantage of incorporating a metal or metal salt throughout a matrix material defining a surface is that as the surface weathers or is damaged during routine use, new surfaces below the original surface can be exposed, where the metal or metal salt can continue to exert its antifouling effect. This feature can be advantageous over a simple surface coating, where a point of damage can become susceptible to fouling.

It is believed that a secondary advantage of the present antifouling surfaces can be that, in some embodiments, they can slowly leach metals or metal salts into a body of water so as to impart some antifouling effects thereto. Although it is believed that the primary antifouling effects of the surfaces described herein occur on the surfaces themselves, it should be recognized that the present surfaces can advantageously introduce a metal or a metal salt continuously to a body of water.

As used herein, the term “antifouling effective amount” refers to an amount of a metal or a metal salt that is sufficient to prevent visible fouling of a surface that is in contact with a body of water or that is periodically exposed to water.

As used herein, the term “does not substantially degrade in the presence of water” refers to a condition in which a matrix material is not dissolved or eroded by water, is not broken into smaller pieces by water, or is not otherwise decomposed by water.

As used herein, the term “fouling” generally refers to biofouling. Illustrative sources of biofouling can include, but are not limited to, algae, bacteria and any incidental biofilm.

In some embodiments, antifouling surfaces described herein can include a matrix material defining a surface that is in contact with a body of water or that is periodically exposed to water, and an antifouling effective amount of a metal additive in the matrix material. The matrix material does not substantially degrade in the presence of water.

In general, matrix materials used in the present antifouling surfaces can include any suitable material that can be used for forming a surface, including those that are traditionally used for a surface being contacted with water. In various embodiments, illustrative matrix materials can include, for example, cements, plaster, gunite, stucco, grout, tile, plastic, vinyl, reinforced plastics (e.g., polymer composites such as fiberglass materials), wood composites, pebble finishes, any combination thereof and the like. As one of ordinary skill in the art will recognize, certain of these materials are not typically used for continuous contact with a water environment but are periodically exposed to a water environment and can be susceptible to biofouling. For example, stucco finishes on a building can be particularly susceptible to mold formation upon exposure to moisture. Likewise, grout materials in showers and bathrooms can be susceptible to mildew growth from residual standing water. Surfaces such as these or any other surface that is in periodic contact with water can benefit from inclusion of a metal or a metal salt according to the embodiments described herein.

In some embodiments, the matrix material can be a Portland cement. The components of a Portland cement can include, for example, calcium oxide (CaO), silicon dioxide (SiO₂), aluminum oxide (Al₂O₃), ferric oxide (Fe₂O₃), calcium carbonate (CaCO₃), and various other sulfate salts. In other embodiments, the matrix material can be a cement other than a Portland cement such as, for example, a Pozzolan-lime cement, a slag-lime cement, a supersulfated cement, a calcium aluminate cement, a calcium sulfoaluminate cement, and the like.

The metal additive can be incorporated within the matrix material at any suitable time. In some embodiments, the metal additive can be incorporated within the matrix material at the time of its manufacture. That is, the metal additive and the matrix material can be provided as a distinct composition. In other embodiments, the metal additive and the matrix material can be mixed on-site before a surface is formed therefrom. In some embodiments, the metal additive and the matrix material can be provided in the form of a kit that is mixed just before use.

In some embodiments, metal additives suitable for use in the present embodiments can include at least one zero-valent metal or at least one metal salt. As used herein, a “zero-valent metal” can be any metal having an oxidation state of zero. In most cases, a zero-valent metal is the metallic form of the metal (i.e., the free metal). However, certain organometallic compounds can also contain a metal having an oxidation state of zero, which can be used in alternative embodiments of the present antifouling surfaces. In general, metal salts suitable for use in the present embodiments can include both soluble and insoluble metal salts such as, for example, oxides, halides (e.g., fluorides, chlorides, bromides and iodides), carbonates, acetates, nitrates, sulfides, sulfates, and the like. In some embodiments, a metal salt can include a metal as part of a complex ion such as, for example, MnO₄²⁻.

In some embodiments, the metal additive can include at least one transition metal. As used herein, the term “transition metal” will refer to any metal, metal alloy, or metal salt having an element from the d-block of the periodic table (Groups 3 through 12). In some embodiments, the metal additive can include at least one zero-valent transition metal. In some embodiments, the metal additive can include at least one transition metal salt.

In some embodiments, metals or metal salts other than transition metals can be used in the metal additive. In some embodiments, a main group metal such as, for example, aluminum can be included in the metal additive. In other embodiments, an alkaline earth metal such as, for example, magnesium can be included in the metal additive. In still other embodiments, a lanthanide metal can be included in the metal additive.

In some embodiments, the metal additive can include at least one metal such as, for example, silver, copper, zinc, iron, manganese, magnesium, aluminum, any alloy or salt thereof, or any combination thereof In some embodiments, the metal additive can include at least silver. In some embodiments, the metal additive can include at least zero-valent silver. In some embodiments, the metal additive can include at least zero-valent silver and at least one other zero-valent metal such as, for example, copper, zinc, iron, manganese, magnesium, aluminum, any alloy thereof, or any combination thereof In some embodiments, the metal additive can include only zero-valent metals. In other embodiments, a combination of zero-valent metals and metal salts can be used. For example, in some embodiments, a combination of zero-valent silver and at least one metal salt can be used.

In various embodiments, the metal additive can be included in the antifouling surfaces in an antifouling effective amount. Suitable antifouling effective amounts can vary from metal to metal and can be determined by routine experimentation. It is also expected that an antifouling effective amount of a metal additive in an antifouling surface can differ from that seen when a like metal additive is dispersed in a liquid. Further, it is expected that an antifouling effective amount for a particular metal can also be dictated somewhat by the nature of the surface itself For example, it is expected that for more porous surfaces, the greater surface area will allow for an increased surface contact of water with the metal additive.

In embodiments in which the metal additive contains silver, the silver can generally be present in an amount ranging between about 0.01 mg/cm³ and about 30 mg/cm³ relative to the matrix material, including all subranges and values in between. In some embodiments, the silver can be present in an amount ranging between about 0.05 mg/cm³ and about 20 mg/cm³ relative to the matrix material or between about 0.1 mg/cm³ and about 15 mg/cm³ relative to the matrix material.

In embodiments in which the metal additive contains copper, the copper can generally be present in an amount ranging between about 0.01 mg/cm³ and about 30 mg/cm³ relative to the matrix material, including all subranges and values in between. In some embodiments, the copper can be present in an amount ranging between about 0.05 mg/cm³ and about 20 mg/cm³ relative to the matrix material or between about 0.1 mg/cm³ and about 15 mg/cm³ relative to the matrix material.

In embodiments in which the metal additive contains zinc, the zinc can generally be present in an amount ranging between about 0.05 mg/cm³ and about 75 mg/cm³ relative to the matrix material, including all subranges and values in between. In some embodiments, the zinc can be present in an amount ranging between about 0.1 mg/cm³ and about 50 mg/cm³ relative to the matrix material or between about 0.5 mg/cm³ and about 30 mg/cm³ relative to the matrix material.

In some embodiments, the metal additive can contain silver in an amount ranging between about 0.01 mg/cm³ and about 30 mg/cm³ relative to the matrix material and at least one of copper or zinc. In some embodiments, the silver can be zero-valent silver. In some embodiments in which copper and/or zinc is/are present with silver, an amount of copper, zinc or a combination thereof in the matrix material can range between about 2% and about 95% by weight of an amount of silver present in the matrix material. In other embodiments, the copper can be present in an amount ranging between about 0.01 mg/cm³ and about 30 mg/cm³ when included with silver, as measured relative to the matrix material. In still other embodiments, the zinc can be present in an amount ranging between about 0.05 mg/cm³ and about 75 mg/cm³ when included with silver, as measured relative to the matrix material. In some embodiments, the copper and/or the zinc can be in a zero-valent state. In some embodiments, the silver, the copper and/or the zinc can all be present in a zero-valent state.

In some embodiments, the metal additive can further include a carrier material for the zero-valent metal or the metal salt. In various embodiments, the carrier material can be a substance that is insoluble or very sparingly soluble in water. Illustrative carrier materials can include, for example, alumina, silica, insoluble carbonates (e.g., any metal carbonate except Group I metal carbonates and ammonium carbonate), and insoluble oxides (e.g., insoluble metal oxides). In some embodiments, the carrier material can be a component of a Portland cement.

When a carrier material is used, the metal additive can be incorporated within the carrier material in some embodiments, or coated on the carrier material in other embodiments. In some embodiments, zero-valent silver can be coated on the surface of the carrier material. Illustrative techniques for depositing zero-valent silver on a carrier material are described in U.S. Pat. Nos. 5,772,896 and 5,935,609, each of which is incorporated herein by reference in its entirety.

Generally, any surface that is in contact with a body of water or can be periodically exposed to water can benefit from the embodiments described herein. Illustrative but non-limiting surfaces that are in contact with a body of water and can benefit from antifouling effects can include, for example, swimming pools, hot tubs, fountains, toilets, boat hulls, docks, buoys, and the like. An even greater benefit can be realized for surfaces that are only periodically exposed to water but are nonetheless subject to biofouling. Illustrative but non-limiting examples of such surfaces can include, for example, spas, showers, bath tubs, patios, sidewalks, bathroom tile and grout, shower curtains, pool coverings, areas surrounding a swimming pool, hot tub, or a spa, and the like. Moreover, building materials such as, for example, stucco, drywall, vinyl siding, brick and wood composites can experience significant biofouling in the presence of moisture and can benefit from the embodiments described herein.

In some embodiments described herein, the antifouling surface can form the surface of a swimming pool or a spa. In some embodiments, the swimming pool or spa can have its entire structure formed from the matrix material and the metal additive contained therein. For example, a swimming pool can be formed from a cement containing a metal additive of the presently described embodiments. In some embodiments, the swimming pool or spa can have its substructure formed from a standard building material such as, for example, concrete, and an antifouling surface of the present disclosure can be placed over its substructure. For example, a swimming pool having a concrete substructure can have an antifouling surface of the present disclosure made from cement, plaster, gunite, vinyl or the like adhered to the concrete substructure. In such embodiments, the metal additive is nearer the surface in contact with water, which can provide its antifouling protection where it is most needed.

In some embodiments, antifouling surfaces described herein can include a matrix material defining a surface that is in contact with a body of water or that is periodically exposed to water, and an antifouling effective amount of a metal additive in the matrix material that includes zero-valent silver or a silver salt. The matrix material does not substantially degrade in the presence of water.

In some embodiments, methods are described herein for inhibiting fouling of a surface that is in contact with a body of water or that is periodically exposed to water. The methods can include incorporating an antifouling effective amount of a metal additive into a matrix material, and forming a surface defined by the matrix material that is in contact with a body of water or that is periodically exposed to water. In such embodiments, the matrix material does not substantially degrade in the presence of water. Further, the metal additive can include at least one zero-valent metal or at least one metal salt.

In some embodiments, the matrix material can be in a softened or uncured state while forming the surface that is in contact with a body of water or that is periodically exposed to water. In some embodiments, the present methods can further include hardening the matrix material after forming the surface. For example, in one embodiment, a swimming pool can be constructed using concrete or gunite, and the surface can be allowed to harden thereafter. In another embodiment, a surface coating containing an uncured matrix material and a metal additive can be applied to a substructure and allowed to cure thereafter. In another embodiment, a surface coating containing a plastic and a metal additive can be heated to a softening temperature, applied to a substructure and cooled to affect hardening thereafter. In still another embodiment, a vinyl sheet containing a metal additive can be preformed and applied to a substructure thereafter.

Although the invention has been described with reference to the disclosed embodiments, one having ordinary skill in the art will readily appreciate that these embodiments are only illustrative of the invention. It should be understood that various modifications can be made without departing from the spirit of the invention. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and operations. All numbers and ranges disclosed above can vary by some amount. Whenever a numerical range with a lower limit and an upper limit is disclosed, any number and any subrange falling within the broader range is specifically disclosed. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted.

What is claimed is the following:

1. An antifouling surface comprising:
a matrix material defining a surface that is in contact with a body of water or that is periodically exposed to water;
wherein the matrix material does not substantially degrade in the presence of water; and
an antifouling effective amount of a metal additive in the matrix material.

2. The antifouling surface of claim 1, wherein the metal additive comprises at least one zero-valent metal or at least one metal salt.

3. The antifouling surface of claim 2, wherein the metal additive comprises at least one zero-valent transition metal.

4. The antifouling surface of claim 2, wherein the metal additive comprises at least one metal selected from the group consisting of silver, copper, zinc, iron, manganese, magnesium, aluminum, alloys thereof, salts thereof, and combinations thereof.

5. The antifouling surface of claim 4, wherein the metal additive comprises at least zero-valent silver.

6. The antifouling surface of claim 5, wherein the metal additive further comprises at least one zero-valent metal selected from the group consisting of copper, zinc, iron, manganese, magnesium, aluminum, alloys thereof, and combinations thereof.

7. The antifouling surface of claim 4, the metal additive comprises silver in an amount ranging between about 0.01 mg/cm³ and about 30 mg/cm³ relative to the matrix material.

8. The antifouling surface of claim 1, wherein the matrix material is selected from the group consisting of cement, plaster, gunite, stucco, grout, tile, plastic, vinyl, reinforced plastic, wood composites, a pebble finish, and combinations thereof.

9. The antifouling surface of claim 1, wherein the metal additive further comprises a carrier material selected from the group consisting of alumina, silica, insoluble carbonates, insoluble oxides, and combinations thereof.

10. The antifouling surface of claim 1, wherein the antifouling surface comprises the surface of a swimming pool or a spa.

11. An antifouling surface comprising:
a matrix material defining a surface that is in contact with a body of water or that is periodically exposed to water;
wherein the matrix material does not substantially degrade in the presence of water; and
an antifouling effective amount of a metal additive that comprises zero-valent silver or a silver salt in the matrix material.

12. The antifouling surface of claim 11, wherein the metal additive further comprises at least one metal selected from the group consisting of copper, zinc, alloys thereof, salts thereof, and combinations thereof.

13. The antifouling surface of claim 12, the metal additive comprises silver in an amount ranging between about 0.01 mg/cm³ and about 30 mg/cm³ relative to the matrix material.

14. The antifouling surface of claim 13, wherein an amount of copper, zinc or a combination thereof in the matrix material ranges between about 2% and about 95% by weight of an amount of silver in the matrix material.

15. The antifouling surface of claim 12, wherein the metal additive comprises only zero-valent metals.

16. The antifouling surface of claim 15, wherein the zero-valent silver is coated on a carrier material selected from the group consisting of alumina, silica, insoluble carbonates, insoluble oxides, and combinations thereof.

17. The antifouling surface of claim 15, wherein the zero-valent silver is incorporated within a carrier material selected from the group consisting of alumina, silica, insoluble carbonates, insoluble oxides, and combinations thereof.

18. The antifouling surface of claim 11, wherein the matrix material is selected from the group consisting of cement, plaster, gunite, stucco, grout, tile, plastic, vinyl, reinforced plastic, wood composites, a pebble finish, and combinations thereof.

19. The antifouling surface of claim 11, wherein the antifouling surface comprises the surface of a swimming pool or a spa.

20. A method for inhibiting fouling of a surface that is in contact with a body of water or that is periodically exposed to water, the method comprising:
incorporating an antifouling effective amount of a metal additive into a matrix material;
wherein the matrix material does not substantially degrade in the presence of water; and
wherein the metal additive comprises at least one zero-valent metal or at least one metal salt; and
forming a surface defined by the matrix material that is in contact with a body of water or that is periodically exposed to water.

21. The method of claim 20, wherein the metal additive comprises at least one metal selected from the group consisting of silver, copper, zinc, iron, manganese, magnesium, aluminum, alloys thereof, salts thereof, and combinations thereof.

22. The method of claim 21, wherein the metal additive comprises at least zero-valent silver.

23. The method of claim 21, wherein the metal additive comprises silver in an amount ranging between about 0.01 mg/cm³ and about 30 mg/cm³ relative to the matrix material.

24. The method of claim 20, further comprising:
hardening the matrix material.
